(19) United States
(12) Patent Application Publication
(10) Pub. No.: US 2022/0376364 A1
(43) Pub. Date: Nov. 24, 2022

(54) BATTERY PACK

(71) Applicants: Doe Hyoung KIM, Seoul (KR); Sung Goo Cho, Seoul (KR); Jeong Keun Ahn, Seoul (KR)

(72) Inventors: Doe Hyoung KIM, Seoul (KR); Sung Goo Cho, Seoul (KR); Jeong Keun Ahn, Seoul (KR)

(21) Appl. No.: 17/746,013

(22) Filed: May 17, 2022

(30) Foreign Application Priority Data
May 18, 2021 (KR) 10-2021-0063851

(51) Int. Cl. H01M 50/516; H01M 50/244; H01M 50/271

(52) U.S. Cl. CPC H01M 50/516; H01M 50/244; H01M 50/271

(57) ABSTRACT

The present invention relates to a battery pack, and more particularly, to a battery pack configured to stably assemble a plurality of secondary batteries. Provided is a battery pack including a plurality of secondary batteries (100), a holder part (200) configured to fix the plurality of secondary batteries (100) so that the plurality of secondary batteries (100) constitute a unit module, and a conductive connection part that is in contact with the plurality of secondary batteries (100) to provide electrical connection with the outside. The holder part (200) are coupled to each of both ends of a positive electrode and a negative electrode of each of the plurality of secondary batteries (100).

### CROSS-REFERENCE TO RELATED APPLICATIONS

This U.S. non-provisional patent application claims priority under 35 U.S.C. § 119 of Korean Patent Application No. 10-2021-0063851, filed on May 18, 2021, the entire contents of which are hereby incorporated by reference.

### FIELD OF THE INVENTION

The present invention disclosed herein relates to a battery pack, and more particularly, to a battery pack configured to stably assemble a plurality of secondary batteries.

### BACKGROUND ART

In general, a secondary battery system is a secondary battery cell assembly constituted by a plurality of battery cells and refers to a cell block that is a basic set, a battery pack configured by connecting a plurality of cell blocks to each other, and the like.

Here, in the process of assembling secondary battery cells having high energy density, safety of the secondary battery and reliability of the entire battery pack may be deteriorated due to inappropriate connection, grounding, and manufacturing defects, and there is a risk of fire with high temperature heat.

Particularly, when a connection part connecting a plurality of secondary batteries to each other is in contact with an external object, short circuit occurs, resulting in overheating of the secondary battery or the fire.

Furthermore, as the connection part connecting the plurality of secondary batteries to each other is in contact with the external object, an internal chemical reaction rate increases to damage the secondary batteries, and thus, the entire battery pack are not used.

In addition, since the connection part connecting the plurality of secondary batteries to each other is cut as much as desired by a user by using iron plate scissors in the related art, there are limitations in that manufacturing is inconvenient, and cost increases.

### SUMMARY OF THE INVENTION

To solve the above-mentioned limitations, the present invention provides a battery pack having improved stability while being capable of being easily manufactured.

In accordance with an embodiment of the present invention, a battery pack includes: a plurality of secondary batteries 100; a holder part 200 configured to fix the plurality of secondary batteries 100 so that the plurality of secondary batteries 100 constitute a unit module; and a conductive connection part that is in contact with the plurality of secondary batteries 100 to provide electrical connection with the outside, wherein the holder part 200 are coupled to each of both ends of a positive electrode and a negative electrode of each of the plurality of secondary batteries 100.

The conductive connection part 300 may be configured to electrically connect the plurality of unit modules to each other.

The conductive connection part 300 may include: a plurality of connection body parts 320 installed on the holder part 200; a connection contact part 310, which is provided in plurality on the connection body parts 320 and is in contact with each of the secondary batteries 100 so as to be electrically connected; and a connection bridge part 330 configured to electrically connect the plurality of connection body parts 320 to each other.

The connection bridge part 300 may include a plurality of cutting holes 340 to be cut from the connection body part 320.

The cutting holes 340 may be defined at positions adjacent to the connection body part 320 of the connection bridge part 330.

The connection contact part 310 may include: an electrical connection plate 312 connected with a first stepped portion from the connection body part 320 toward the secondary battery 100; an electrical connection contact part 311 that is in contact with the secondary battery 100 with a second stepped portion from the electrical connection plate 312; and a first stepped portion connection part 314 through which the electrical connection plate (312) and the connection body part 320 are connected to each other with the first stepped portion.

The battery pack may further include a substrate part 500 provided above the plurality of secondary batteries 100 disposed to be stacked in a horizontal direction so that both electrodes define side surfaces, respectively.

The conductive connection part 300 may further include a substrate connection part 350 extending upward to be in contact with the substrate part 500 so that the substrate part 500 and the plurality of secondary batteries 100 are electrically connected to each other.

The battery pack may further include a guard part 400 provided to extend upward from an upper end of the holder part 200 coupled to each of both the electrodes of the plurality of secondary batteries 100.

The guard part 400 may include an opening 401 through which the substrate connection part 350 passes.

The battery pack may further include a cover part 700 installed on an outer surface of the holder part 200 installed on each of both the electrodes of the plurality of secondary batteries 100 to cover the plurality of secondary batteries 100 and the holder part 200.

The cover part 700 may include: a cover plate 710 disposed on the outer surface of the holder part 200; and a cover bolt 720 coupled to the holder part 200 by passing through the cover plate 710 to fix the cover plate 710.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a plan view illustrating a connection part of a battery pack according to an embodiment of the present invention;

FIG. 2 is a side view illustrating the connection part of the battery pack of FIG. 1;

FIG. 3 is a perspective view of the battery pack of FIG. 1 according to an embodiment;

FIG. 4 is a cross-sectional view of the battery pack of FIG. 4;

FIG. 5 is a partial perspective view of the battery pack of FIG. 1 according to another embodiment;

FIGS. 6A and 6B are plan views illustrating a state before and after welding a connection part of a battery pack of FIG. 5;

FIG. 7 is a partial perspective view illustrating a state in which the connection part of the battery pack of FIG. 5 is installed; and

FIG. 8 is a perspective view of the battery pack of FIG. 5.

### DETAILED DESCRIPTION OF THE PREFERRED EMBODIMENTS

Hereinafter, a battery pack according to the present invention will be described with reference to the accompanying drawings.

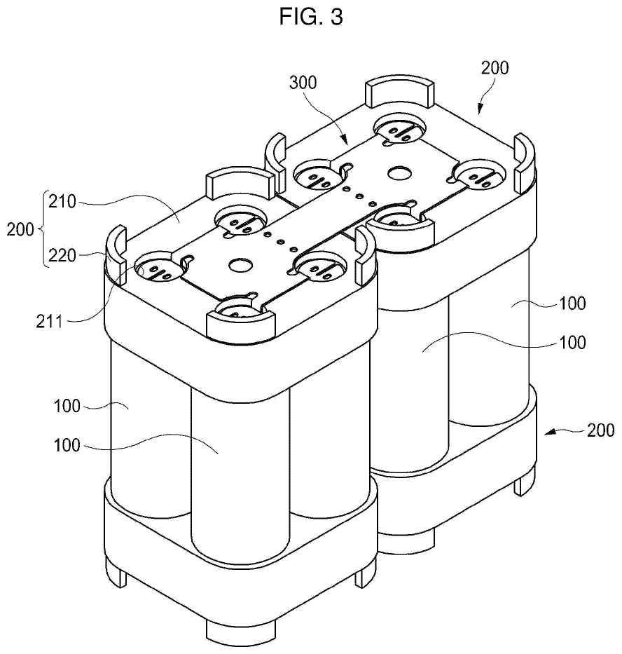

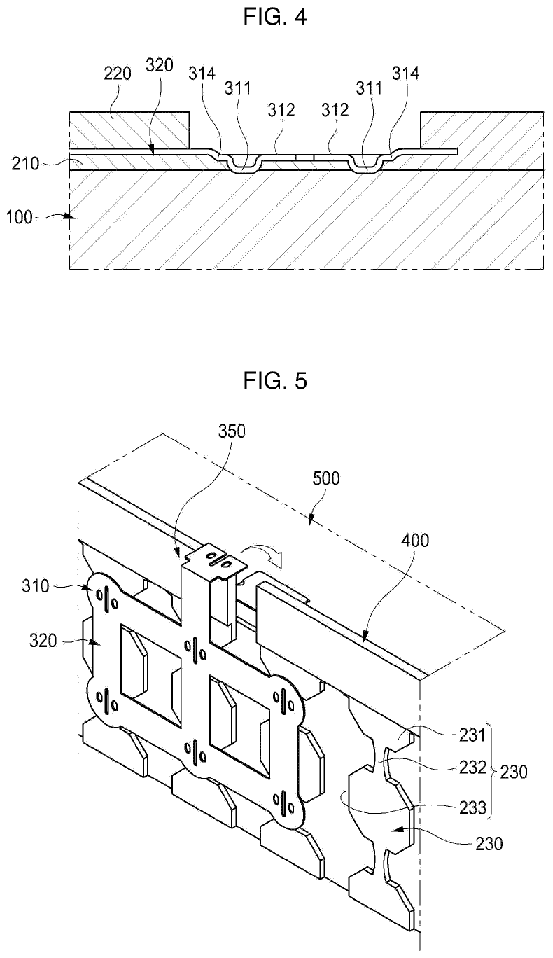

As illustrated in FIG. 3, a battery pack according to the present invention includes a plurality of secondary batteries 100, a holder part 200 fixed so that the plurality of secondary batteries 100 are provided as a unit module, and a conductive connection part 300 that is in contact with the plurality of secondary batteries 100 to electrically connect the plurality of secondary batteries 100 to the outside.

In addition, the battery pack according to the present invention may further include a substrate part 500 provided above the plurality of secondary batteries 100 disposed to be stacked in a horizontal direction so that both electrodes define side surfaces, respectively.

In addition, the battery pack according to the present invention may further include a guard part 400 provided to extend upward from an upper end of the holder part 200 that is coupled to each of both the electrodes of the plurality of secondary batteries 100.

In addition, the battery pack according to the present invention may further include a cover part 700 installed on an outer surface of the holder part 200 installed on each of both the electrodes of the plurality of secondary batteries 100 to cover the plurality of secondary batteries 100 and the holder part 200.

A double-stepped structure of the conductive connection part 300 as a main feature according to the present invention will be described in detail below.

The conductive connection part 300 may be a configuration that is in contact with the plurality of secondary batteries 100 to electrically connect the plurality of secondary batteries to the outside and may have various configurations.

For example, the conductive connection part 300 may have one end, which is in contact with the electrodes disposed both ends of the plurality of secondary batteries 100, and the other end, which is in contact with the secondary batteries 100 of the external or adjacent unit module.

That is, the conductive connection part 300 may electrically connect the plurality of unit modules to each other.

As an example, the conductive connection part 300 includes a plurality of connection body parts 320 installed in contact with the holder part 200, a connection contact part 310, which is provided in plurality on the connection body parts 320 and is in contact with each of the secondary batteries 100 so as to be electrically connected to the secondary batteries 100, and a connection bridge part 330, which electrically connects the plurality of connection body parts to each other.

In addition, the conductive connection part 300 may include a plurality of cutting holes 340 defined so that the connection body part 320 and the connection bridge part 330 are easily cut by stress.

The conductive connection part 300 may be made of a nickel metal that is capable of being electrically connected and easily welded.

The connection body part 320 is a configuration installed in contact with the holder part 200 and has various configurations.

For example, the connection body part 320 may include a connection body plate 321 installed on the holder part 200 and a connection body expansion part 322 expanded from the connection body plate 321 to connect the connection contact part 310 to be described later to the connection body plate 321.

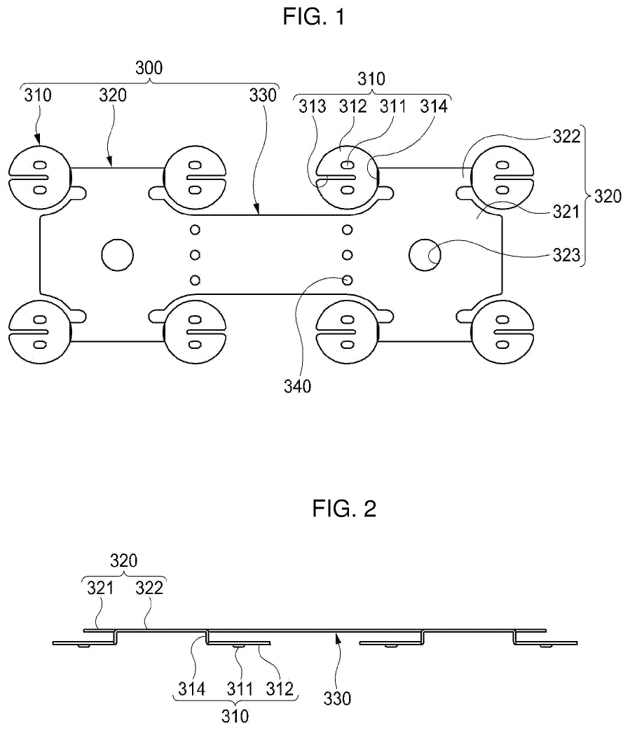

In more detail, as illustrated in FIG. 1, the connection body part 320 may include the connection body plate 321 installed on the holder part 200 and having an opening 323 at a center thereof and the connection body expansion part 322 connected to the connection contact part 310 so that the connection contact part 310 is disposed at a position corresponding to each of four vertexes with respect to the connection body plate 321.

The connection contact part 310 is provided in plurality, which are disposed on the connection body parts 320, respectively, and is configured to be electrically connected in contact with each of the secondary batteries 100, and also has various configurations.

For example, the connection contact part 310 includes an electrical connection plate 312 connected with a first stepped portion from the connection body part 320 toward the secondary battery 100, an electrical connection contact part 311 that is in contact with the secondary battery 100 with a second stepped portion from the electrical connection plate 312, and a first stepped portion connection part 314 through which the electrical connection plate 312 and the connection body part 320 are connected to each other with the first stepped portion.

That is, as illustrated in FIG. 2 with respect to the connection body part 320, the connection contact part 310 may be provided downward with the first stepped portion and thus be disposed to be inserted toward the secondary battery 100. Furthermore, the electrical connection contact part 311 that is in contact with the electrode of the secondary battery 100 may be disposed with an additional second stepped portion from the electrical connection plate 312 toward the secondary battery 100.

Therefore, the connection contact part 310 may be in stable electrical contact with the secondary battery 100 through the first and second stepped portions, and thus, the contact with the external object may be minimized to prevent damage due to grounding.

The connection bridge part 330 is a configuration that electrically connects the plurality of connection body parts 320 to each other and has various configurations.

For example, the connection bridge part 330 may electrically connect the plurality of connection body parts 320 to each other to electrically connect the connection body part 320 installed in one unit module to the connection body part 320 installed in the adjacent unit module.

Thus, the connection bridge part 330 may electrically connect the plurality of unit modules to each other.

A process of cutting the conductive connection part 300 as a mean feature of the present invention will be described in detail.

The cutting hole 340 may be configured so that the connection bridge part 330 and the connection body part 320 are easily cut through stress.

In more detail, as illustrated in FIG. 1, the cutting hole 340 may be defined to pass through the connection bridge part 330, thereby performing the cutting according to external stress provided by the user or the like.

Here, the cutting hole 340 may have a simple through-hole shape, and as another example, the cutting hole 340 may have any shape provided by a polygonal planar shape, a circular shape, and a combination thereof.

The cutting hole 340 may be defined in a position adjacent to the connection body part 320 of the connection bridge part 330, and more specifically, may be provided in plurality along a cutting line on a boundary of the connection bridge part 330 between the connection bridge part 330 and the connection body part 320.

Contents of the holder 200, which are main features of the present invention, will be described in detail below.

The plurality of secondary batteries 100 are configured to supply power through charging and discharging and may be applied to a secondary battery having any shape, which is disclosed in the related art.

The plurality of secondary batteries 100 may be provided as one unit module, and a plurality of unit modules may be packed to be provided. As another example, the plurality of secondary batteries 100 may be packaged and provided as one unit module.

The plurality of secondary batteries 100 may provide a unit module in a plurality of preset sets. More specifically, as illustrated in FIG. 3, four secondary batteries 100 may be assembled to constitute one unit modules.

Also, ten or more, i.e., a plurality of secondary batteries may be configured as one unit module, and a plurality of sets of four unit modules may be assembled to be packed.

As illustrated in FIG. 3, in the plurality of secondary batteries 100, in a state in which four secondary batteries 100 are assembled to constitute one unit module, the holder parts 200 to be described later may be coupled to upper and lower portions so as to be fixed to each other. For another example, as illustrated in FIG. 5, in a state in which both the electrodes are stacked to provide the side surfaces, the holder parts 200 may be coupled on both the side surfaces that correspond to both the electrodes so as to be fixed to each other.

That is, in the plurality of secondary batteries 100, the holder parts 200 may be respectively coupled at positions of a positive electrode and a negative electrode, which are provided at both ends, to fix and assemble the plurality of secondary batteries 100. Here, the positive electrode and the negative electrodes may be disposed in a vertical direction or disposed in a lateral direction.

The holder part 200 is a configuration that fixes the plurality of secondary batteries 100 to constitute the unit module and has various configurations.

For example, the holder part 200 may be coupled at each of both the ends of the positive and negative electrodes of the plurality of secondary batteries 100 so that the plurality of secondary batteries 100 are fixed to constitute the unit module.

For example, as illustrated in FIG. 3, the holder part 200 may include upper and lower holders 210 that are inserted into and coupled to the secondary batteries 100 in a state, in which four secondary batteries 100 are assembled, and a protrusion 220 extending from each of the upper and lower holders 210 in a direction opposite to the secondary battery 100.

Here, as illustrated in FIG. 3, the holder part 200 may be inserted and coupled to both ends of the upper and lower portions of the secondary batteries 100 in a state in which the four secondary batteries 100 are erected and assembled.

In this case, the upper and lower holders 210 inserted into both the ends may be spaced apart from each other so that the side surfaces of the plurality of secondary batteries 100 are exposed. For another example, the upper and lower holders inserted into both the ends may be in contact with each other at the central side.

For another example, the holder part 200 may be a configuration in which the plurality of secondary batteries 100 are inserted and coupled and which is provided as a housing having a separate inner space so that the secondary batteries 100 are inserted therein.

In addition, each of the upper and lower holders 210 may have a contact hole 211 defined in each of both the ends of the secondary battery 100 at a position corresponding to the connection contact part 310 so that the connection contact part 310 of the conductive connection part 300 is in contact with the secondary battery 100.

The protrusion 220 is a configuration extending from each of the upper and lower holders 210 in the direction opposite to the secondary battery 100 and may have various configurations.

For example, the protrusion 220 may extend from the outermost side of each of the upper and lower holders 210 in the direction opposite to the secondary battery 100 to prevent the conductive connection part 300, which will be described later, from being in contact with the external object.

Here, the protrusion 220 may be disposed along an edge of each of the upper and lower holders 210. For another example, the protrusion 220 may be provided in plurality at positions corresponding to vertexes of the upper and lower holders 210 as illustrated in FIG. 3.

Particularly, the protrusion 220 may be provided so that the conductive connection part 300 installed to be electrically connected through packing between the plurality of unit modules is stably guided or inserted to be installed.

For another example, as illustrated in FIG. 5, when the plurality of secondary batteries 100 are stacked in the horizontal direction so that both the electrodes provide the side surfaces, the holder part 200 may be coupled to each of both the ends of the plurality of secondary batteries 100 to fix the secondary batteries 100 and provide side surface of the battery pack.

Here, the holder part 200 may include a side holder 230 in which a guide opening 233 is defined so that the conductive connection part 300 to be described later is inserted and installed.

In more detail, the side holder 230 may include a plurality of side holder cover parts 231 for preventing other portions except for the electrodes provided at both the ends of the secondary battery 100 from being exposed to the outside, the guide opening 233 defined between the plurality of side holder cover parts 231 to provide an installation space of the conductive connection part to be described later and a contact space with the secondary battery 100, and a side holder bridge 232 connecting the plurality of side holder cover parts 231 to each other.

That is, the side holder 230 may be installed to prevent the plurality of secondary batteries 100 from being exposed and to fix the secondary batteries 10, and may have the guide opening 233 so that the conductive connection part is installed to provide electrical contact between the secondary battery 100 and the conductive connection part 300.

In this case, the conductive connection part 300 may be inserted into the guide opening 233 and installed at a relatively inner side toward the secondary battery 100 rather than the side holder cover part 231. Thus, the conductive connection part 300 may be in contact with the side holder cover part 231 even in contact with the external object to prevent the conductive connection part 300 from being in contact with the conductive connection part 300.

An installation structure of the substrate part 500 and a configuration of the guard part 400 that protects the substrate part 500 will be described in detail below.

The substrate part 500 is a configuration provided above the plurality of secondary batteries 100 stacked in the horizontal direction so that both the electrodes provide the side surfaces, respectively, and has various configurations.

For example, the substrate part 500 may be connected to each of the secondary batteries 100 to control the charging and discharging of the secondary batteries 100 or to control power to be used.

In the substrate part 500, a printed circuit board may be installed above the plurality of secondary batteries 100 when the plurality of secondary batteries 100 are stacked in the horizontal direction.

The guard part 400 is a configuration provided to extend upward from an upper end of the holder part 200 coupled to each of both the electrodes of the plurality of secondary batteries 100, respectively, and has various configurations.

For example, the guard part 400 is a configuration installed upward from the upper end of the holder part 200, which is coupled to each of both the electrodes of the plurality of secondary batteries 100 to provide the side surfaces, i.e., installed higher than the substrate part 500 to protect the substrate part 500 therein.

The guard part 400 may include an opening 401 defined so that the substrate connection part 350 to be described later passes therethrough. In more detail, a plurality of guard parts 400 may be installed along the upper end of the holder part 200 to define the opening 401 with an interval between the adjacent guard parts 400.

For another example, a passing opening through which the substrate connection part 350 to be described later may be defined in the guard part 400 to define the opening.

The substrate connection part 350 is a configuration extending upward from the connection body part 320 or the connection contact part 310 to be in contact with the substrate part 500 so as to electrically connect the substrate part 500 to the plurality of secondary batteries 100 and has various configurations.

For example, the substrate connection part 350 has one end that extends from the connection body unit 320 and the other end that extends upward from the side surface, on which the holder part 200 is installed, and is bent to be in contact with the substrate part 500 disposed on a top surface thereof.

Here, as illustrated in FIG. 5, the substrate connection part 350 may include a substrate connection plate 352 including a welding portion 351 coupled to the substrate part 500 by welding and a substrate connection strip 354 connecting the substrate connection plate 352 to the connection body part 320.

As illustrated in FIG. 5, the substrate connection part 350 may be installed to pass through the opening 401 defined in the guard part 400 in a state in which the substrate connection strip 354 is inserted into the guide opening 233 defined in the holder part 200. Here, the substrate connection plate 352 may be bent toward the top surface of the substrate part 500 to induce the contact with the substrate part 500.

In this case, the substrate connection part 350 may have a stepped portion 353 expanded in the horizontal direction at a side of the guard part 400 based on the state in which the substrate connection plate 352 is in contact with the substrate part 500. As a result, even in a state in which the substrate connection plate 352 is separated from the substrate part 500, the substrate connection plate 352 may interfere with the guard part 400 to prevent the substrate connection part 350 from being exposed to the outside.

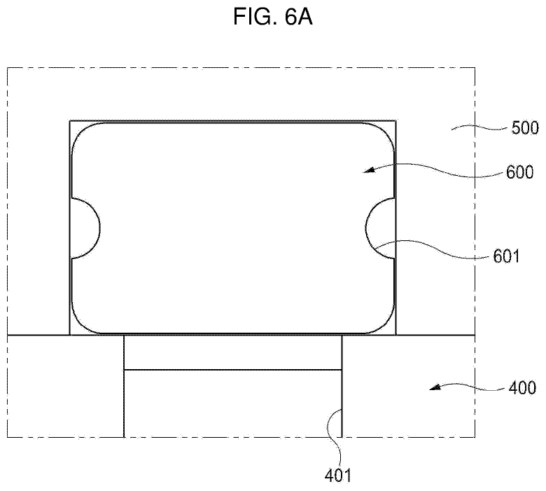

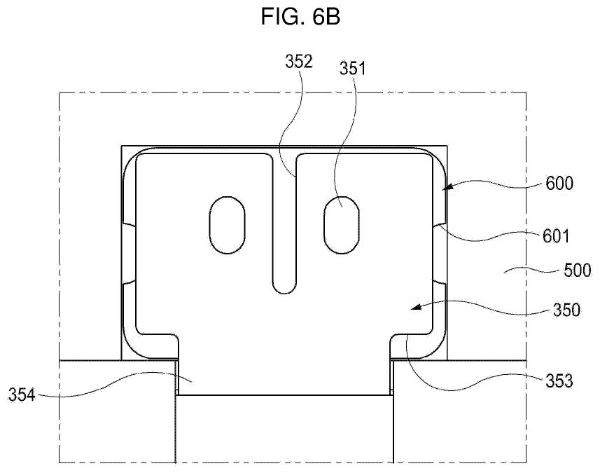

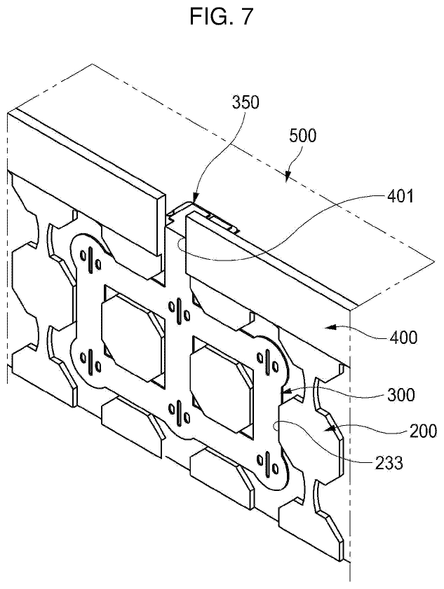

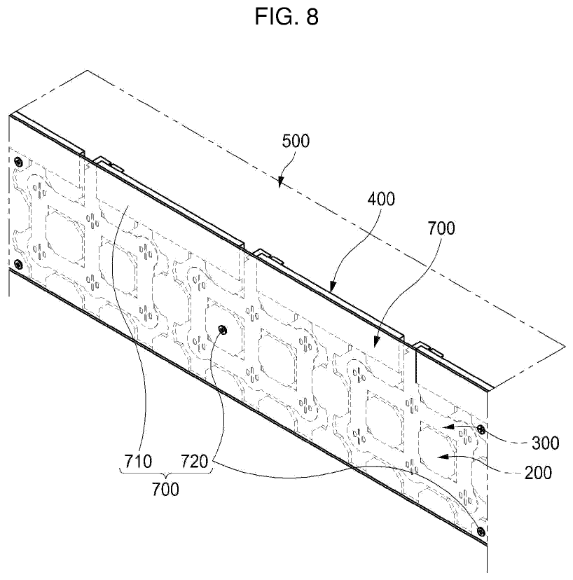

That is, as illustrated in FIG. 6A, a stepped portion 353 may be provided so that a width of the substrate connection plate 352 is greater than that of the opening 401 on a plane to prevent the substrate connection part from being exposed to and being in contact with the outside due to the interfere with the guard part 400 even when being separated from the substrate connection part 350, particularly the substrate part 500 of the substrate connection plate 352.

Meanwhile, a process of connecting the conductive connection part 300 and the substrate part 500 as a main feature of the present invention will be described in detail below.

The battery pack according to the present invention may further include a welding plate 600 installed at a welding position with the substrate connection part 350 of the substrate part 500.

As illustrated in FIGS. 6A and 6B, the welding plate 600 is installed at the welding position with the substrate connection part 350 of the substrate part 500 and is welded to the substrate connection part 350 to connect the substrate part 500 to the substrate connection part 350.

In this process, the existing substrate part 500 may be made of a copper material, and thus, it is difficult to be welded to the substrate connection part 350 made of a nickel material, thereby deteriorating welding reliability.

To solve this limitation, the welding plate 600 made of the nickel material may be installed on the substrate part 500 so that the substrate connection part 350 is maintained in a more reliable coupling state through the welding between the same nickel materials, and then, the substrate connection part 350 may be welded to the welding plate 600.

The welding plate 600 may be installed to the substrate part 500 by various methods such as simple coupling, bolt coupling, and the like. For example, the welding plate 600 may be mounted on the surface of the substrate part 500 through a surface mounting technology (SMT) and then be soldered to be installed.

Here, the welding plate 600 may include at least one notch 601, for example, a notch 601 on each of both surfaces on the plane so as to be soldered to the substrate part 500, and thus, may be easily aligned with the substrate part 500.

The cover part 700 that covers the holder part 200, which is a main feature of the present invention, will be described in detail.

The cover part 700 is a configuration that is installed on an outer surface of the holder part 200 installed on each of both the electrodes of the plurality of secondary batteries 100 to cover the plurality of secondary batteries 100 and the holder part 200 and has various configurations.

For example, the cover part 700 may include a cover plate 710 disposed on the outer surface of the holder part 200 and a cover bolt 720 coupled to the holder part 200 by passing through the cover plate 710 to fix the cover plate 710.

The cover plate 710 may be disposed on the outer surface of the holder part 200 to prevent the whole configurations such as the secondary batteries 100, the conductive connection part 300, and the like in addition to the holder part 200 from being exposed to the outside.

The cover bolt 720 may be configured to pass through the cover plate 710 and be coupled to the holder part 200 to fix the cover plate 710.

The battery pack according to the present invention may have the advantages of being easily manufactured, increasing in versatility, and reducing the manufacturing time and cost by simply cutting and utilizing the connection part of the plurality of secondary batteries at the predetermined pressure according to the user's needs.

Particularly, the battery pack according to the present invention may have the advantage of being easily manufactured because the connection part of the plurality of secondary batteries are cut and utilized by the user's repeated stress without using the separate tool.

In addition, the battery pack according to the present invention may have the advantages of being easily manufactured and improving the coupling reliability by more easily welding the connection part of the plurality of secondary batteries.

In addition, the battery pack according to the present invention may have the advantage of preventing the safety accident in advance by fundamentally blocking the connection part of the plurality of secondary batteries from being in contact with the external ground.

Particularly, the battery pack according to the present invention may have the advantage of preventing the contact with the external ground even when the connection part of the secondary batteries are separated.

Furthermore, the battery pack according to the present invention may have the advantage of reducing the risk of the fire and the damage of the entire battery pack, enhancing the durability, and stably supplying the energy by preventing the connection portion from being in contact with the external ground in advance.

Although the above description merely corresponds to some exemplary embodiments that may be implemented by the present invention, as well known, the scope of the present invention should not be interpreted as being limited to the above-described embodiments, and all technical spirits having the same basis as that of the above-described technical spirit of the present invention are included in the scope of the present invention.

What is claimed is:

1. A battery pack comprising:
a plurality of secondary batteries;
a holder part configured to fix the plurality of secondary batteries so that the plurality of secondary batteries constitute a unit module; and
a conductive connection part that is in contact with the plurality of secondary batteries to provide electrical connection with the outside,
wherein the holder part is coupled to each of both ends of a positive electrode and a negative electrode of each of the plurality of secondary batteries.

2. The battery pack of claim 1, wherein the conductive connection part is configured to electrically connect the plurality of unit modules to each other.

3. The battery pack of claim 1, wherein the conductive connection part comprises:
a plurality of connection body parts installed on the holder part;
a connection contact part, which is provided in plurality on the connection body parts and is in contact with each of the secondary batteries so as to be electrically connected; and
a connection bridge part configured to electrically connect the plurality of connection body parts to each other.

4. The battery pack of claim 3, wherein the connection bridge part comprises a plurality of cutting holes to be cut from the connection body part.

5. The battery pack of claim 4, wherein the cutting holes are defined at positions adjacent to the connection body part of the connection bridge part.

6. The battery pack of claim 3, wherein the connection contact part comprises:
an electrical connection plate connected with a first stepped portion from the connection body part toward the secondary battery;
an electrical connection contact part that is in contact with the secondary battery with a second stepped portion from the electrical connection plate; and
a first stepped portion connection part through which the electrical connection plate and the connection body part are connected to each other with the first stepped portion.

7. The battery pack of claim 1, further comprising a substrate part provided above the plurality of secondary batteries disposed to be stacked in a horizontal direction so that both electrodes define side surfaces, respectively.

8. The battery pack of claim 7, wherein the conductive connection part further comprises a substrate connection part extending upward to be in contact with the substrate part so that the substrate part and the plurality of secondary batteries are electrically connected to each other.

9. The battery pack of claim 7, further comprising a guard part provided to extend upward from an upper end of the holder part coupled to each of both the electrodes of the plurality of secondary batteries.

10. The battery pack of claim 8, wherein the guard part comprises an opening through which the substrate connection part passes.

11. The battery pack of claim 7, further comprising a cover part installed on an outer surface of the holder part installed on each of both the electrodes of the plurality of secondary batteries to cover the plurality of secondary batteries and the holder part.

12. The battery pack of claim 11, wherein the cover part comprises:
a cover plate disposed on the outer surface of the holder part; and
a cover bolt coupled to the holder part by passing through the cover plate to fix the cover plate.
